(19) United States
(12) Patent Application Publication
(10) Pub. No.: US 2025/0373965 A1
(43) Pub. Date: Dec. 4, 2025

(54) DIGITAL MICROPHONE DATA OUTPUT

(71) Applicant: SensiBel AS, Oslo (NO)

(72) Inventor: Øyvind Janbu, Oslo (NO)

(21) Appl. No.: 19/220,859

(22) Filed: May 28, 2025

(30) Foreign Application Priority Data
May 31, 2024 (GB) 2407734.9

(51) Int. Cl. H04R 1/00

(52) U.S. Cl. CPC H04R 1/005; H04R 2201/003

(57) ABSTRACT

A digital microphone system includes a digital microphone, a host circuit and an output data line. The host circuit is configured to provide a periodic clock signal to the digital microphone, wherein the periodic clock signal has a period comprising a first clock signal portion when the periodic clock signal is high and a second clock signal portion when the periodic clock signal is low. The digital microphone system is configured to cause the digital microphone to output acoustic signal data to the host circuit via the data line during the first and second clock signal portions.

### CROSS REFERENCE TO RELATED APPLICATIONS

This application claims priority to United Kingdom Patent Application No. 2407734.9 filed May 31, 2024, the contents of which are incorporated herein in their entirety.

### FIELD

This invention relates generally to outputting data from digital microphones, and in particular (but not exclusively) to methods and systems for outputting data from digital microphones that are capable of being used in a multiplexed digital microphone system.

### BACKGROUND

Various methods are known in the art for outputting acoustic signal data from a digital microphone in order for the acoustic signal data, which corresponds to the acoustic waves detected by the microphone, to be used in a chosen application.

Some digital microphones are manufactured to allow them to be used in multiplexed digital microphone systems. Two or more such microphones may then be assembled into a digital microphone system to allow data to be output from the microphones in a multiplexed manner onto a shared data line to a host circuit.

Various methods of multiplexing data are known in the art. In general, the concept of multiplexing involves coordinating the microphones using a periodic clock signal so that each microphone outputs one bit of data per clock cycle during a respective designated portion of the periodic clock signal onto the shared data line. The clock signal is typically a square wave signal with a rising edge and a falling edge each cycle (e.g. with a 50% duty cycle). Each microphone in the multiplexed system is configured to output one bit of data per clock cycle. The multiplexing protocol defines how the microphones are coordinated so that they output their data bits onto the shared data line at different times from one another. For example, in a two-channel multiplexed Pulse Density Modulation (PDM) protocol for two microphones, in each clock cycle the first microphone commences outputting its data bit on the rising edge of the clock signal and the second microphone commences outputting its data bit on the falling edge, so that the output of the second microphone's data bit is delayed until after the first microphone has finished outputting its data bit. This means that the data bits from the two microphones do not overlap on the shared data line. In other protocols, one microphone may output a data bit each clock cycle for a fixed number of clock cycles while the other microphone does not output any data, then vice versa.

Multiplexing may provide various advantages, e.g. avoiding the need for a dedicated data line for each microphone, but further improvements in methods and systems for outputting data from digital microphones are desirable.

### SUMMARY OF THE INVENTION

The invention provides a digital microphone system, comprising:
a digital microphone;
a host circuit configured to provide a periodic clock signal to the digital microphone, wherein the periodic clock signal has a period comprising a first clock signal portion when the periodic clock signal is high and a second clock signal portion when the periodic clock signal is low; and
an output data line;
wherein the digital microphone system is configured to cause the digital microphone to output acoustic signal data to the host circuit via the data line during the first and second clock signal portions.

The invention extends to a method of outputting data from a digital microphone system, wherein the digital microphone comprises:
a digital microphone;
a host circuit configured to provide a periodic clock signal to the digital microphone, wherein the periodic clock signal has a period comprising a first clock signal portion when the periodic clock signal is high and a second clock signal portion when the periodic clock signal is low; and
an output data line;
the method comprising causing the digital microphone to output acoustic signal data from the digital microphone to the host circuit via the data line during the first and second clock signal portions.

Thus it can be seen that systems and methods in accordance with the invention may provide the benefit of doubling the amount of data that can be provided by a digital microphone for a given clock rate. This may in turn allow a higher dynamic range to be achieved for the microphone. From another perspective, a given desired data rate or dynamic range can be achieved using a lower clock rate (which implies a lower power consumption).

A “digital microphone” in this context may be understood to refer to a microphone that outputs an acoustic signal (i.e. a signal corresponding to an acoustic wave detected by the microphone) in a digital form. For example, the digital microphone may comprise an analogue microphone operating in conjunction with one or more analogue-to-digital converters (ADCs) and corresponding signal processing. The acoustic signal data may be output as bits of data, e.g. outputting acoustic signal data during a clock signal portion may comprise outputting a single bit of acoustic signal data during the clock signal portion. The microphone may output a portion (e.g. one bit) of acoustic signal data responsive to a rising edge of the periodic clock signal. The microphone may output a further portion (e.g. one further bit) of acoustic signal data responsive to a falling edge of the periodic clock signal.

The microphone may use a digital output protocol to output the acoustic signal data digitally, e.g. implemented by a digital interface. Various kinds of digital interfaces are known in the art for outputting data from digital microphones, and the digital microphone system may be configured to use any suitable digital interface. For example, the digital microphone system may be configured to use a Pulse Density Modulation (PDM) interface. The method may comprise using a Pulse Density Modulation interface. This may provide the advantage of being low latency, which may be important in some applications, e.g. noise cancelling.

Digital microphones may be manufactured to use a particular digital interface to output data in a suitable form. Digital microphones may also be configured to allow multiplexing of data using different clock signal portions of a clock signal period, so that multiple microphones can output data to a host circuit via a shared data line, e.g. such as a channel 1 microphone and a channel 2 microphone in a two-channel audio system using a PDM interface. This implies that when using microphones manufactured with this configuration, each microphone can only output data part of the time. For example, in a PDM system, each digital microphone may be configured either to output a bit while the clock signal is high and then to output no data while the clock signal is low, or to output a bit while the clock signal is low and then to output no data while the clock signal is high. Each PDM microphone would therefore be able to output data only half of the time.

The Applicant has appreciated that digital microphones manufactured for conventional multi-microphone systems (i.e. manufactured for multiplexed use) can be repurposed for non-multiplexed (e.g. single-microphone) applications based on the principles described above in relation to the invention, i.e. by reconfiguring the digital microphone system's operation so that the microphone uses not only its own allocated portion of the periodic clock signal, but another portion that would normally be allocated to a further microphone in a multi-microphone system.

In some embodiments, the digital microphone is adapted for use in a multiplexed digital microphone system comprising a multiplexed digital interface for outputting acoustic signal data from the digital microphone during a clock signal portion (e.g. when the clock signal is high) and for outputting acoustic signal data from a further digital microphone during another clock signal portion (e.g. when the clock signal is low). Thus it can be seen that in accordance with embodiments of the present invention, a microphone that is manufactured to output data during only part of a clock signal period may be used to output data at a higher rate, e.g. at a rate of two bits each per clock signal period instead of one bit per clock signal period.

Accordingly, the benefits of the invention may be obtained in digital microphone systems that do not necessarily include a second microphone. In some circumstances it may be desirable or sufficient to use only one microphone for an application. In some embodiments, the digital microphone system has only a single digital microphone, i.e. the digital microphone is the only digital microphone in the digital microphone system. However, this is not essential. In a set of embodiments, the digital microphone is a first digital microphone and the digital microphone system comprises a second digital microphone, wherein the host circuit is configured to provide the periodic clock signal to the second digital microphone, and the data line is a shared data line.

In a subset of the embodiments mentioned in the preceding paragraph, the digital microphone system is configured to be operable in a multiplexed data mode and a multiple data rate mode, wherein the multiplexed data mode comprises:
the first digital microphone outputting acoustic signal data to the host circuit via the shared data line during the first clock signal portion; and
the second digital microphone outputting acoustic signal data to the host circuit via the shared data line during the second clock signal portion; and
wherein the multiple data rate mode comprises:
the first digital microphone outputting acoustic signal data to the host circuit via the shared data line during the first and second clock signal portions; and
the second digital microphone outputting no acoustic signal data to the host circuit via the shared data line during the first and second clock signal portions.

The method may comprise operating the digital microphone system in the multiple data rate mode.

Thus it can be seen that when the second digital microphone is not in use and therefore not using the second clock signal portion to output data, operation of the first digital microphone may be changed to use both the first and second clock signal portions. This may provide the benefit of doubling the amount of data that can be provided for a given clock rate when the digital microphone system is operated with only one microphone in use.

The multiple data rate mode may be a double data rate mode, e.g. in a system with only two microphones.

The method may comprise operating the digital microphone system in the multiplexed data mode. The method may comprise switching between the multiplexed data mode and the multiple data rate mode. Thus it can be seen that the invention may advantageously allow a multiplexed digital microphone system to operate with an increased data rate at times when only one microphone is required while also allowing the possibility of multiplexing the output of the digital microphones at times when more than one microphone is required or desired.

Optional features described with reference to the digital microphone (corresponding to the first digital microphone) may also be optional features of the first and/or second digital microphones as defined above and vice versa.

The or each digital microphone may be any suitable type of microphone. The or each digital microphone may be a capacitive microphone.

As mentioned above, in digital microphone systems in accordance with the invention, a higher dynamic range may be achieved for a given clock rate. This may be particularly beneficial in digital microphone systems employing optical microelectromechanical systems (MEMS), because the dynamic range of the microphone itself is high. The present invention may therefore help to obtain the full benefit (or more of the benefit) of the optical MEMS microphone's inherent high dynamic range.

The or each digital microphone may be a microelectromechanical systems (MEMS) microphone. The meaning of the term micro-electromechanical system (MEMS) is well understood by a person skilled in the art, so it will be understood that when a microphone is described as being a “MEMS microphone”, this means that the microphone comprises miniaturized mechanical and/or electro-mechanical elements or structures. Such miniaturized elements and structures may have been made using microfabrication techniques, where miniaturized means that the physical dimensions of the miniaturized elements are on the scale of micrometres, e.g. up to a millimetre.

In a set of embodiments, the or each digital microphone is an optical microphone, for example an optical MEMS microphone and/or for example using optical interferometric read out. For example, the or each digital microphone may comprise:
an interferometric arrangement comprising a first optical element and a second optical element, wherein the first optical element is moveable with respect to the second optical element;
a light source; and
a photo detector;
wherein the light source is disposed to provide light to the interferometric arrangement such that a first portion of said light propagates along a first optical path via said interferometric arrangement and a second portion of said light propagates along a second different optical path via said interferometric arrangement, thereby giving rise to an optical path difference between the first and second optical paths which depends on a distance between the first optical element and the second optical element, and the photo detector is disposed to detect at least part of an interference pattern generated by said first and second portions of light dependent on said optical path difference.

The first optical element may comprise, for example, a membrane, e.g. that moves in response to an incoming acoustic wave. The first and/or second optical element may comprise, for example, a diffraction grating or a reflective surface.

It will be seen from the above disclosure that in the context of a “shared data line”, the term “shared” may be understood to mean that the shared data line is useable by the both the first and second microphones to send data to the host circuit.

It is to be understood that when it is said that acoustic signal data is output during a clock signal portion, this implies that the acoustic signal data is output a portion at a time (e.g. one bit at a time) during that clock signal portion over multiple clock signal periods, e.g. as a data stream, rather than implying that the same acoustic signal data is repeatedly output during the clock signal portion of successive clock periods.

For example, in accordance with the multiplexed data mode, the first (or second) digital microphone may output one bit of acoustic signal data during the first (or second) clock signal portion in one period of the periodic clock signal, then the first (or second) digital microphone may output a further bit of acoustic signal data during the first (or second) clock signal portion in a subsequent period of the periodic clock signal, etc.

Similarly, in accordance with the multiple data rate mode, the first digital microphone may output a first bit of acoustic signal data during the first clock signal portion of a first clock period, then a second bit of acoustic signal data during the second clock signal portion of the first clock period, then a third bit during the first clock signal portion of a second, subsequent clock period, then a fourth bit during the second clock signal portion of said second period, etc.

The first and second clock signal portions may be the same in each period of the periodic clock signal, e.g. the first clock signal portion may correspond to the first half of each period, and the second clock signal portion may correspond to the second half of each period. The first clock signal portion may correspond to (e.g. commence at) the rising edge of the periodic clock signal and the second clock signal portion may correspond to (e.g. commence at) the falling edge of the periodic clock signal.

The digital microphone system may comprise a controller function configured to control operation of the digital microphone system, e.g. so that it outputs the acoustic signal data during the first clock signal portion and the second clock signal portion, and/or so that it operates according to the multiplexed data mode and/or the multiple data rate mode.

The controller function may comprise a central controller function. The host circuit may provide the central controller function. Additionally or alternatively, the controller function may comprise one or microphone controller functions. The or each digital microphone may provide a respective one of the microphone controller functions.

The controller function (e.g. the central controller function, or the microphone controller function(s)) may control the first and second digital microphones to cause them to output the acoustic signal data in accordance with the multiplexed data mode and the multiple data rate mode as defined above.

The controller function (e.g. the central controller function, or the microphone controller function(s)) may control the or each digital microphone (e.g. in response to the periodic clock signal) to cause it/them to output the acoustic signal data during the first and second clock signal portions.

The or each microphone controller function may be configured to cause the digital microphone or a corresponding one of the digital microphones to output a data bit i) only during the first clock signal portion; ii) only during the second clock signal portion; iii) during each of the first and second clock signal portions; or iv) during neither of the first and second clock signal portions.

The controller function may be implemented in any suitable way. It may be implemented in software, e.g. configured over I2C or hard-coded, e.g. it may comprise one or more physical controllers.

The digital microphone system may be configurable (e.g. by a person installing the digital microphone system in a device or a person using the digital microphone system) to set the multiplexed data mode or the multiple data rate mode for operation of the digital microphone system and/or to switch between the multiplexed data mode and the multiple data rate mode.

The method may comprise configuring the digital microphone system (e.g. by configuring the controller function) to set the multiplexed data mode or the multiple data rate mode for operation of the digital microphone system. The method may comprise configuring the digital microphone system (e.g. by configuring the controller function) to switch between the multiplexed data mode and the multiple data rate mode.

### BRIEF DESCRIPTION OF THE DRAWINGS

Certain preferred embodiments will now be described, by way of example only, with reference to the accompanying drawings, in which:

FIG. 1 shows an example of conventional digital microphone system configured for multiplexed data output using Pulse Density Modulation (PDM);

FIG. 2 shows an example of a PDM microphone that is used in the example of FIG. 1 and also in the embodiment of FIG. 4 in accordance with the invention;

FIG. 3 shows a timing diagram illustrating data output for mono and stereo output from the example digital microphone system of FIG. 1;

FIG. 4 shows an embodiment of a digital microphone system in accordance with the present invention;

FIG. 5 shows a timing diagram illustrating multiple data rate output from the digital microphone system of FIG. 4;

FIG. 6 shows a further embodiment of a digital microphone system in accordance with the present invention; and

FIG. 7 shows an example of an optical microphone suitable for use in embodiments of a digital microphone system in accordance with the present invention.

### DETAILED DESCRIPTION OF THE DRAWINGS

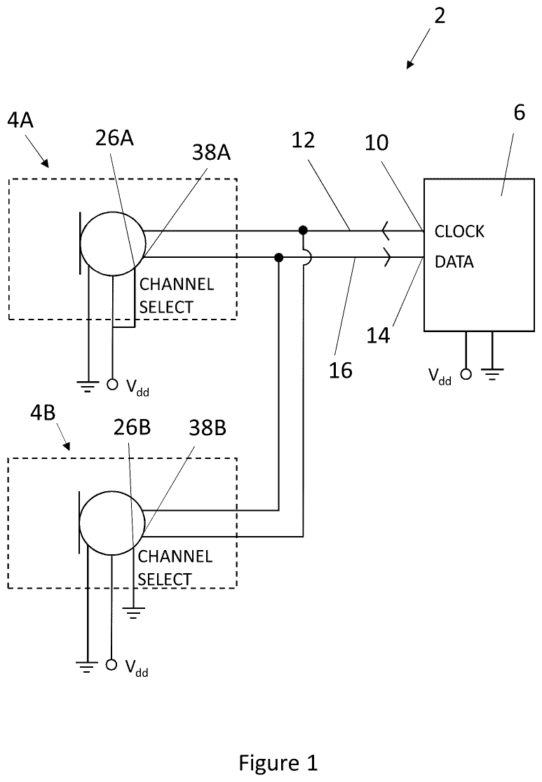

FIG. 1 shows an example of conventional digital microphone system 2 configured for multiplexed data output using Pulse Density Modulation (PDM). The digital microphone system 2 comprises a first digital microphone 4A, a second digital microphone 4B and a host circuit 6. In this example, the first digital microphone 4A corresponds to a first channel labelled “Channel A” and the second digital microphone 4B corresponds to a second channel labelled “Channel B” in a two-channel microphone configuration. In other examples and variations, the first digital microphone 4A could be the left microphone and the second digital microphone 4B could be the right microphone in a stereo microphone configuration. The host circuit 6 interfaces the first and second digital microphones 4A, 4B through a PDM interface, as discussed further below.

The host circuit 6 comprises a “CLOCK” output pin 10, which outputs a periodic clock signal via a shared clock signal line 12 to the first and second digital microphones 4A, 4B. The host circuit 6 also comprises a “DATA” input pin 14, which receives data via a shared data line 16 from the first and second digital microphones 4A, 4B.

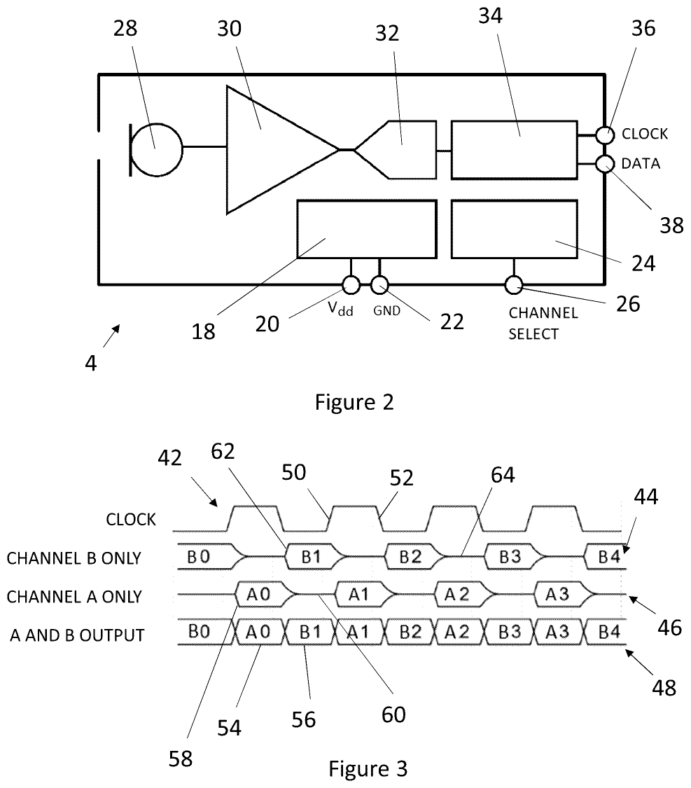

Each of the first and second digital microphones 4A, 4B has a structure as illustrated in detail by the digital microphone 4 depicted in FIG. 2. The reference numerals used in FIG. 2 refer generally to the construction of the digital microphone 4 that is used for both the first and second digital microphones 4A, 4B. Where the first and second digital microphones 4A, 4B are referred to individually with reference to FIG. 1, the same reference numerals from FIG. 2 are used, but with an A or B appended to refer to the first (channel A) and second (channel B) digital microphones respectively.

As can be seen from FIG. 2, the structure of the digital microphones 4 comprises a power management module 18 for powering the digital microphone 4, with connections 20, 22 to a voltage supply Vad and to ground. Each digital microphone 4 also comprises a channel select module 24 with a channel select pin 26, whose function is described later with reference to FIG. 3.

Each digital microphone 4 also comprises an acoustic sensor element 28, an amplifier 30, and analogue-to-digital converter (ADC) 32, and a PDM modulator 34. The acoustic sensor element 28 outputs a signal corresponding to the amplitude of an incoming acoustic wave. The signal is passed to the amplifier 30, which amplifies the signal appropriately for the application. The amplified signal is passed to the ADC 32 which converts the amplified signal to a digital signal in the form of quantized sampling of the amplified signal. The digital signal is passed to the PDM modulator 34.

The PDM modulator 34 has a “CLOCK” input pin 36, which receives a periodic clock signal from the host circuit 6 (see FIG. 1). The PDM modulator 34 also has a “DATA” output pin 38 connected to the “DATA” input pin 14 of the host circuit 6. The PDM modulator 34 encodes the digital signal as a PDM digital signal and outputs the PDM digital signal on the “DATA” output pin 38 in a multiplexed way, as described below. How to encode a signal using PDM is generally known in the art. It typically involves transmitting a series of bits where the density of “1” bits in the series corresponds to the amplitude of to the signal being encoded. In the present example, one bit of the series of bits may be transmitted per clock period during a portion of the periodic clock signal allocated to the microphone (e.g. the microphone may be allocated the high portion or the low portion of the periodic clock signal).

FIG. 3 shows a timing diagram illustrating the periodic clock signal 42 as well as channel B mono data output 44, channel A mono data output 46 and stereo output 48 from digital microphone system 2 of FIG. 1. As can be seen from FIG. 3, the periodic clock signal 42 has approximately the form of a square wave with a 50% duty cycle, i.e. at the start of the period, there is a rising edge 50 of the period clock signal 42, and half way through the period, there is a falling edge 52.

As mentioned above, each digital microphone 4 comprises a channel select module 24 and a channel select pin 26. The channel select module 24 is configured such that when the channel select pin 26 is connected to Vad, the digital microphone 4 outputs one bit of data of the PDM signal to the “DATA” output pin 38 while the periodic clock signal 42 is high (i.e. following the rising edge 50 of the periodic clock signal 42), and outputs no data while the periodic clock signal 42 is low (i.e. following the falling edge 52). The channel select module 24 is further configured such that when the channel select pin 26 is connected to ground, the digital microphone 4 outputs one bit of data of the PDM signal to the “DATA” output pin 38 while the periodic clock signal 42 is low (i.e. following the falling edge 52 of the period clock signal 42), and outputs no data while the periodic clock signal 42 is high (i.e. following the rising edge 50). However, it is to be understood that this is just an example and this configuration could be reversed or otherwise different.

As can be seen from FIG. 1, the first digital microphone 4A has its channel select pin 26A connected to Vad, and the second digital microphone 4B has its channel select pin 26B connected to ground. The first (channel A) digital microphone 4A therefore outputs one bit 54 (see FIG. 3) of its PDM signal data to its output pin 38A on each rising edge 50 of the periodic clock pulse 42, and the second (channel B) digital microphone 4B outputs one bit 56 of its PDM signal data to its output pin 38B on each falling edge 52 of the periodic clock pulse 42. The data provided on each output pin 38 is combined via the shared data line 16 and provided to the “DATA” input pin 14 on the host circuit 6. Accordingly, as can be seen from FIG. 3, the stereo data output 48 provided to the host circuit 6 via the shared data line 14 comprises the channel A and channel B data output from each of the first and second digital microphones 4A, 4B respectively multiplexed onto the shared data line 14.

FIG. 3 also shows the channel A output data 46 and the channel B output data 44 provided to the shared data line 14 for each of the first (channel A) and second (channel B) digital microphones 4A, 4B under mono operation. In the case that the first (channel A) digital microphone 4A is under mono operation, the first digital microphone 4A outputs one bit of data 58 on each rising edge 50 of the periodic clock cycle, but the second (channel B) digital microphone 4B does not output any data. The output data 46 provided to the shared output line 14 therefore comprises one bit 58 per clock period provided during the first half of the period, and an empty slot 60 corresponding to the second half of the period, where there would have been one bit of data each cycle from the second digital microphone 4B if that microphone were operating. In the case that the second (channel B) digital microphone 4B is under mono operation, there is similarly one bit 62 per clock period in the second half of the period, which is output by the second digital microphone 4B, and an empty slot 64 for the first half of the period that would have been occupied by data from the first digital microphone 4A if that microphone were operating.

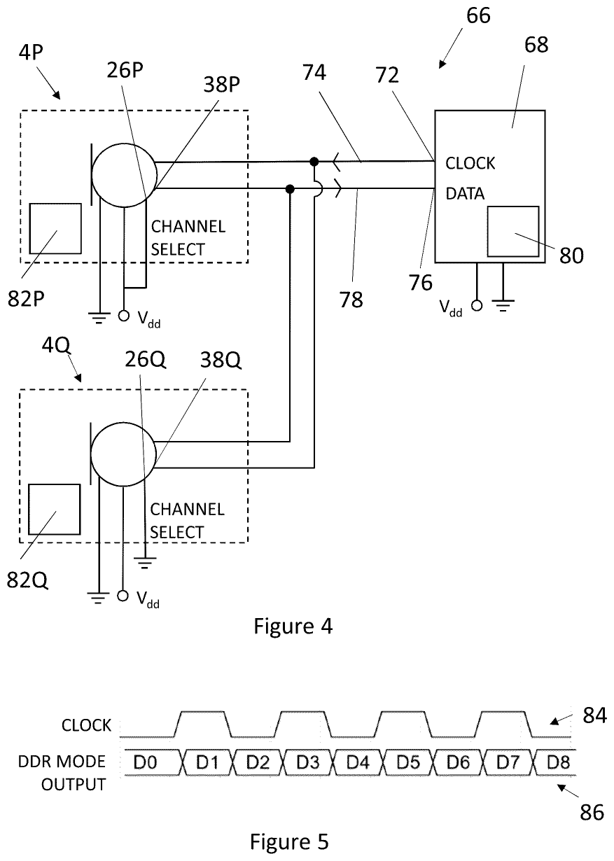

FIG. 4 shows an embodiment of a digital microphone system 66 in accordance with the present invention, which is configured for multiplexed data output and multiple rate data output using Pulse Density Modulation (PDM). The digital microphone system 66 comprises a first digital microphone 4P, a second digital microphone 4Q and a host circuit 68. In this example, the first digital microphone 4P corresponds to a first channel labelled “Channel P” and the second digital microphone 4Q corresponds to a second channel labelled “Channel Q” in a two-channel microphone configuration. In other examples and variations, the first and second digital microphones 4P, 4Q could be configured as a stereo microphone pair, e.g, wherein the first digital microphone 4P is the left microphone and the second digital microphone 4Q is the right microphone.

Similar to the example of FIG. 1, the host circuit 68 interfaces the first and second digital microphones 4P, 4Q through a PDM interface, but the manner in which data is output from the first and second digital microphones 4P, 4Q is different from the example conventional digital microphone system 2 described above with reference to FIGS. 1 to 3.

The host circuit 68 of the digital microphone system 66 comprises a “CLOCK” output pin 72, which outputs a periodic clock signal via a shared clock signal line 74 to the first and second digital microphones 4P, 4Q. The host circuit 68 also comprises a “DATA” input pin 76, which receives data via a shared data line 78 from the first and second digital microphones 4P, 4Q.

In this example, the first and second digital microphones 4P, 4Q have a construction that is suitable for use in a conventional digital microphone system using a PDM interface to multiplex the microphone output data onto a shared data line, although this is not essential. In this example, the first and second digital microphones 4P, 4Q have the same construction as the digital microphone 4 depicted in and described above with reference to FIG. 2. Where the first and second digital microphones 4P, 4Q or their features are discussed individually with reference to FIG. 4, the same reference numerals from FIG. 2 are used, but with an P or a Q appended to refer to the first and second digital microphones 4P, 4Q respectively.

The digital microphone system 66 has a distributed controller function which comprises a central controller function 80 and respective microphone controller functions 82P, 82Q. The central controller function 80 could be implemented in hardware or software. In this embodiment it is implemented as part of the host circuit 68, but this is just an example.

The first and second digital microphones 4P, 4Q provide the respective first and second microphone controller functions 82P, 82Q. The microphone controller functions 82P, 82Q could be implemented in hardware or software, e.g. configured over I2C.

The central controller function 80 sets an operational mode of each of the microphone controller functions 82P, 82Q. Depending on the operational mode set, each microphone controller function 82P, 82Q controls its respective digital microphone 4P, 4Q to output a data bit i) only when the periodic clock signal is high; ii) only when the periodic clock signal is low; iii) both when the periodic clock signal is high and when the periodic clock signal is low; or iv) neither when the periodic clock signal is high nor when the periodic clock signal is low. By setting suitable operational modes for each microphone controller function 82P, 82Q, the central controller function 80 causes the digital microphone system 66 to operate according to a multiplexed data mode or a multiple data rate mode, and can switch between the two modes.

In the multiplexed data mode, the first microphone controller function 82P controls the first digital microphone 4P to output a data bit to the shared data line only when the periodic clock signal is high, and the second microphone controller function 82Q controls the second digital microphone 4Q to output a data bit to the shared data line only when the periodic clock signal is low. The digital microphone system 66 therefore outputs data to the host circuit 68 on the shared data line 78 in the same manner as in the conventional digital microphone system 2 of FIG. 1.

In the multiple data rate mode, only one of the digital microphones 4P, 4Q is used. The use of the first digital microphone 4P in the multiple data rate mode is described below with reference to FIGS. 4 and 5. In this example embodiment, it is also possible to operate the second digital microphone 4Q in the multiple data rate mode.

In the multiple data rate mode, the first microphone controller function 82P controls the first digital microphone 4P to output a data bit to the shared data line both when the periodic clock signal is high and when the periodic clock signal is low, i.e. two data bits per periodic clock cycle. The second microphone controller function 82Q controls the second digital microphone 4Q to output no data when the periodic clock signal is high and also to output no data when the periodic clock signal is low, i.e. only the first digital microphone 4P outputs data.

FIG. 5 shows a timing diagram illustrating the periodic clock signal 84 and the output data 86 provided to the shared data line 74. Each bit of data D0, D1, D2, D3, etc. is output from the first digital microphone 4P, with one bit being output during each of the clock signal portions so that two bits are output per cycle of the periodic clock signal 84, i.e. one while the periodic clock signal 84 is high and one while the periodic clock signal 84 is low.

It can thus be seen that when the digital microphone system 66 of FIG. 4 operates using only the first digital microphone 4P, the first digital microphone 4P is made to use the second digital microphone's unused clock signal portion (corresponding to the second half of the periodic clock cycle 84), allowing twice as much data to be output to the host circuit 68 compared with the output from a single microphone in a conventional multiplexed digital microphone system, such as that shown in FIG. 1.

The second digital microphone 4Q can be used in a similar manner to output data in the multiple data rate mode by setting the operational modes of the first and second microphone controller functions accordingly.

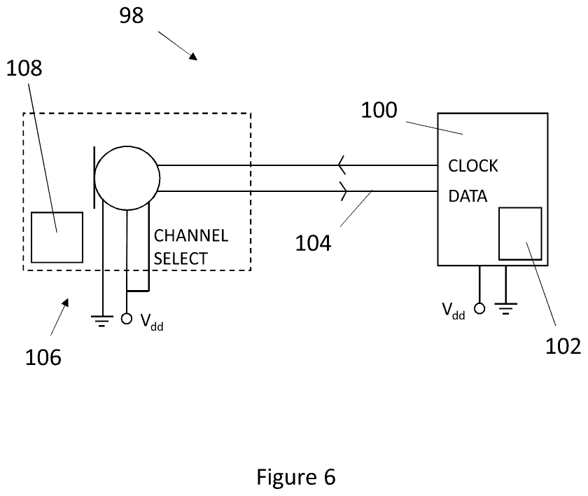

FIG. 6 shows a further embodiment of a digital microphone system 98 in accordance with the invention. This embodiment is variation on the digital microphone system 66 of FIG. 4 that is suitable for applications in which only one microphone is ever used, e.g. such that the second digital microphone and the multiplexed data mode may be omitted.

The digital microphone system 98 of FIG. 6 has the same structure as the digital microphone system 66 of FIG. 4, including a host circuit 100 and a central controller function 102 (which may be implemented in hardware or software), except that the second digital microphone is not provided, and the corresponding lines and pins providing input to or receiving output from the host circuit are not present or are modified accordingly. The data line 104 is not a shared data line, but only receives data from the first digital microphone 106 (which in this embodiment is the only digital microphone). The periodic clock signal is provided only to the first digital microphone 106. The first digital microphone 106 has a microphone controller function 108 which controls the first digital microphone 106 in the same way as described with reference to FIGS. 4 and 5 to output a data bit to the data line 104 both when the periodic clock signal is high and when the periodic clock signal is low. This causes the first digital microphone 106 to output two data bits per cycle, i.e. in the same manner as in the multiple data rate mode described above with reference to FIG. 4.

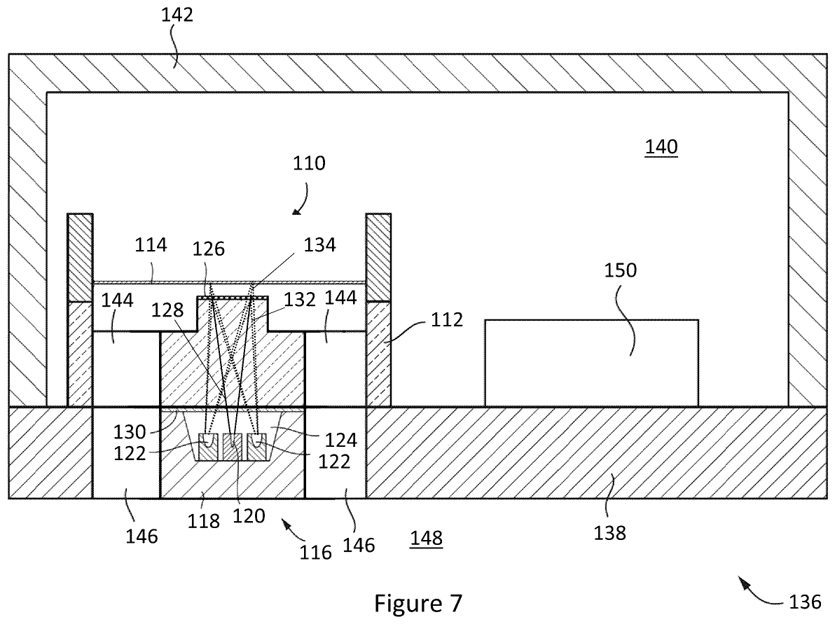

FIG. 7 shows an example of an optical microphone 110 that is suitable for use in embodiments in accordance with the present invention. For example, the optical microphone 110 may be used in the digital microphones 4A, 4B, 4P, 4Q in accordance with the embodiments described above.

The optical microphone 110 comprises a substrate 112 and a membrane 114. The optical microphone 110 also comprises an optical readout module 116, which comprises a mount 118, a light source 120 (e.g. a VCSEL: a vertical-cavity surface-emitting laser), and two photo detectors 122. The optical readout module 116 is sealed to the bottom of the substrate 112 so that the light source 120 and photo detectors 122 are sealed within a recess 124 in the mount 118. The membrane 114 is positioned on top of the substrate 112 so as to provide the membrane 114 in a spaced relationship with a diffraction grating 126 fabricated on an upper surface region of the substrate 112.

In use, the light source 120 emits radiation 128 towards the diffraction grating 126. An anti-reflection coating 130 is provided on the lower surface of the substrate 112 to improve the coupling of radiation 128 into and through the substrate 112. A first portion 132 of the radiation is diffracted and reflected back from the diffraction grating 126 and impinges on the photo detectors 122. A second portion 134 of the radiation is diffracted and transmitted through the diffraction grating 126 and is reflected from the membrane 114 back through the diffraction grating 126 and impinges on the photo detectors 122. Where the first and second portions 132, 134 overlap, the radiation interferes. The resultant intensity of radiation at the photo detectors depends on the distance between the membrane 114 and the diffraction grating 126. As such, the intensity detected at the photo detectors 122 can be related to the separation between the membrane 114 and the diffraction grating 126, and thus to the movement of the membrane 114 when subject to an acoustic wave which causes the membrane 114 to vibrate.

The optical microphone 110 is housing in a package 136 comprising a package base 138 and an enclosure 142. A first side of the membrane 114 is in fluid communication with an acoustic cavity 140 formed by the enclosure 142. The substrate 112 comprises apertures 144 and the package base 138 comprises apertures 146 so that a second side of the membrane 114 is in fluid communication with the exterior 148 of the optical microphone 110 (i.e. its ambient surroundings). When an incoming acoustic wave impinges on the second side of the membrane 114, this creates a pressure differential causing the membrane 114 to vibrate. The displacement of the membrane 114 (i.e. its separation from the diffraction grating 126) corresponds to the amplitude of the acoustic wave. Measuring the separation between the membrane 114 and the diffraction grating 126 as described above thus allows the amplitude of the acoustic wave to be determined. In this example, signals from the photo detectors 122 are processed to determine the amplitude of the acoustic wave by an application-specific integrated circuit (ASIC) 150 on the package base 138.

1. A digital microphone system, comprising:
a digital microphone;
a host circuit configured to provide a periodic clock signal to the digital microphone, wherein the periodic clock signal has a period comprising a first clock signal portion when the periodic clock signal is high and a second clock signal portion when the periodic clock signal is low; and
an output data line;
wherein the digital microphone system is configured to cause the digital microphone to output acoustic signal data to the host circuit via the data line during the first and second clock signal portions.

2. The digital microphone system of claim 1, wherein the digital microphone is adapted for use in a multiplexed digital microphone system comprising a multiplexed digital interface for outputting acoustic signal data from the digital microphone during a clock signal portion and for outputting acoustic signal data from a further digital microphone during another clock signal portion.

3. The digital microphone system of claim 1, comprising a controller function configured to control operation of the digital microphone system so that it outputs the acoustic signal data during the first clock signal portion and the second clock signal portion.

4. The digital microphone system of claim 1, wherein the digital microphone system has only a single digital microphone.

5. The digital microphone system of claim 1, wherein:
the digital microphone is a first digital microphone;
the digital microphone system comprises a second digital microphone;
the host circuit is configured to provide the periodic clock signal to the first and second digital microphones; and
the data line is a shared data line.

6. The digital microphone system of claim 5, wherein the digital microphone system is configured to be operable in a multiplexed data mode and a multiple data rate mode;
wherein the multiplexed data mode comprises:
the first digital microphone outputting acoustic signal data to the host circuit via the shared data line during the first clock signal portion; and
the second digital microphone outputting acoustic signal data to the host circuit via the shared data line during the second clock signal portion; and
wherein the multiple data rate mode comprises:
the first digital microphone outputting acoustic signal data to the host circuit via the shared data line during the first and second clock signal portions; and
the second digital microphone outputting no acoustic signal data to the host circuit via the shared data line during the first and second clock signal portions.

7. The digital microphone system of claim 6, comprising a controller function configured to control operation of the digital microphone system so that it operates according to at least one of the multiplexed data mode and the multiple data rate mode, wherein the controller function is configurable to perform at least one of i) setting the multiplexed data mode or the multiple data rate mode for operation of the digital microphone system and ii) switching between the multiplexed data mode and the multiple data rate mode.

8. The digital microphone system of claim 1, wherein the digital microphone is a microelectromechanical systems optical microphone.

9. The digital microphone system of claim 1, wherein the digital microphone system is configured to use a Pulse Density Modulation interface.

10. A method of outputting data from a digital microphone system, wherein the digital microphone comprises:
a digital microphone;
a host circuit configured to provide a periodic clock signal to the digital microphone, wherein the periodic clock signal has a period comprising a first clock signal portion when the periodic clock signal is high and a second clock signal portion when the periodic clock signal is low; and
an output data line;
the method comprising causing the digital microphone to output acoustic signal data from the digital microphone to the host circuit via the data line during the first and second clock signal portions.

11. The method of claim 10, wherein the digital microphone is adapted for use in a multiplexed digital microphone system comprising a multiplexed digital interface for outputting acoustic signal data from the digital microphone during a clock signal portion and for outputting acoustic signal data from a further digital microphone during another clock signal portion.

12. The method of claim 10, wherein the digital microphone system comprises a controller function configured to control operation of the digital microphone system so that it outputs the acoustic signal data during the first clock signal portion and the second clock signal portion.

13. The method of claim 10, wherein the digital microphone system has only a single digital microphone.

14. The method of claim 10, wherein:
the digital microphone is a first digital microphone;
the digital microphone system comprises a second digital microphone;
the host circuit is configured to provide the periodic clock signal to the first and second digital microphones; and
the data line is a shared data line.

15. The method of claim 14, wherein the digital microphone system is configured to be operable in a multiplexed data mode and a multiple data rate mode, wherein the multiplexed data mode comprises:
the first digital microphone outputting acoustic signal data to the host circuit via the shared data line during the first clock signal portion; and
the second digital microphone outputting acoustic signal data to the host circuit via the shared data line during the second clock signal portion;
the method comprising operating the digital microphone system in the multiple data rate mode, which comprises:
the first digital microphone outputting acoustic signal data to the host circuit via the shared data line during the first and second clock signal portions; and
the second digital microphone outputting no acoustic signal data to the host circuit via the shared data line during the first and second clock signal portions.

16. The method of claim 15, wherein digital microphone system comprises a controller function configured to control operation of the digital microphone system so that it operates according to at least one of the multiplexed data mode and the multiple data rate mode.

17. The method of claim 15, further comprising configuring the digital microphone system to set the multiplexed data mode or the multiple data rate mode for operation of the digital microphone system.

18. The method of claim 15, further comprising configuring the digital microphone system to switch between the multiplexed data mode and the multiple data rate mode.

19. The method of claim 10, wherein the digital microphone is a microelectromechanical systems optical microphone.

20. The method of claim 10, comprising using a Pulse Density Modulation interface to output the acoustic signal data.
